(19) United States
(12) Patent Application Publication
(10) Pub. No.: US 2011/0060626 A1
(43) Pub. Date: Mar. 10, 2011

(54) STORM WATER POLLUTION PREVENTION SYSTEM AND METHOD

(75) Inventors: Ted Gattino, Parkton, MD (US); Kevin Hedge, Ellicott City, MD (US)

(73) Assignee: Blue Wing Environmental Solutions & Technologies, Crofton, MD (US)

(21) Appl. No.: 12/879,180

(22) Filed: Sep. 10, 2010

Related U.S. Application Data
(60) Provisional application No. 61/241,040, filed on Sep. 10, 2009.

(51) Int. Cl. G06Q 10/00; G06Q 90/00

(52) U.S. Cl. 705/9; 705/500; 705/7

(57) ABSTRACT

A storm water pollution prevention management system and method is disclosed. The method may include receiving a site map of a construction site, creating an overlay for the received site map, receiving identification of inspectable items on the construction site, placing symbols on the created overlay related to the received inspectable items, receiving one or more discrepancies related to the inspectable items, placing an identification mark on the overlay to identify each of the one or more discrepancies, and creating an inspection report identifying one or more of the one or more discrepancies and providing information concerning each of the one or more discrepancies.

### PRIORITY INFORMATION

This non-provisional application claims priority from U.S. Provisional Application Ser. No. 61/241,040, filed, Sep. 10, 2009, the content of which priority is incorporated herein by reference in its entirety.

### BACKGROUND OF THE DISCLOSED EMBODIMENTS

1. Field of the Disclosed Embodiments

The disclosed embodiments relate generally to systems and methods in the field of storm water pollution prevention programs (SWPPP), and more particularly, to an electronic system for providing a single point of management, information collection and reporting for individual and/or multiple sites to Federal and State agencies and internally to a client's staff to help verify and maintain compliance documentation.

2. Introduction

Ready access to information is critical to many aspects of people's lives. The information required often exists in many places, but not always in the places the information would be most useful. As an example, the information about residential and commercial construction sites exists in various databases and other locations for specific uses, such as discrepancies on the site that may have a negative impact on the environment. However, there currently does not exist a centralized system of tracking such discrepancies which if gone unchecked, may lead to damage to the environment.

### SUMMARY OF THE DISCLOSED EMBODIMENTS

A storm water pollution prevention management system and method is disclosed. The method may include receiving a site map of a construction site, creating an overlay for the received site map, receiving identification of inspectable items on the construction site, placing symbols on the created overlay related to the received inspectable items, receiving one or more discrepancies related to the inspectable items, placing an identification mark on the overlay to identify each of the one or more discrepancies, and creating an inspection report identifying one or more of the one or more discrepancies and providing information concerning each of the one or more discrepancies.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary diagram of a storm water pollution prevention management environment in accordance with a possible embodiment of the disclosure;

FIG. 2 is an exemplary block diagram of a storm water pollution prevention management system in accordance with a possible embodiment of the disclosure;

FIG. 3 is an exemplary flowchart of a storm water pollution prevention management process in accordance with one possible embodiment of the disclosure;

FIG. 4 is an exemplary site map overlay showing discrepancies in accordance with a possible embodiment of the disclosure; and

FIG. 5 is an exemplary inspection report identifying discrepancies on a site in accordance with a possible embodiment of the disclosure.

### DESCRIPTION OF THE DISCLOSED EMBODIMENTS

Additional features and advantages of the disclosed embodiments will be set forth in the description which follows, and in part will be obvious from the description, or may be learned by practice of the disclosed embodiments. The features and advantages of the disclosed embodiments may be realized and obtained by means of the instruments and combinations particularly pointed out in the appended claims. These and other features of the present disclosed embodiments will become more fully apparent from the following description and appended claims, or may be learned by the practice of the disclosed embodiments as set forth herein.

Various embodiments of the disclosed embodiments are discussed in detail below. While specific implementations are discussed, it should be understood that this is done for illustration purposes only. A person skilled in the relevant art will recognize that other components and configurations may be used without parting from the spirit and scope of the disclosed embodiments.

The proposed disclosed embodiments concern systems and methods in the field of storm water pollution prevention programs (SWPPP). The system may include a database structure that may be set up to handle multiple construction projects for each customer. In general, each project may be associated with one site plan, or map. However, a subsequent construction phase (for example, Phase 2) may be allowed for a particular site or project, which may be covering the same area (i.e., map) as in Phase 1. This situation may occur when there is an initial rough or mass grading and infrastructure construction phase and a subsequent final grading and construction phase may be required. User account information may be held in a master database, for example.

There may be a single Login portal for all users. Different user permissions may, generally, generate different “looks” and access levels based on each user's specific assigned login group. The various groups of users are discussed below, in the “Actors” section. Each login group may have a set of default permissions. Initially, only Super-Admin users may be able to create new customers. A Super-Admin may log into the system and create the customer. In all phases, Super-Admins may also administer user accounts at the highest level, including Company Admins, and generally have master access to the entire system.

The system may use an email address for the user name and all passwords may be encrypted. However, user names may also be any name chosen by a user, as long as it conforms to any minimum requirements that may be determined.

The application may be designed such that the graphic design and overall layout of the pages may be changed at any time. It may be built upon a flexible set of templates that can be updated to effect changes on all pages that depend on that template.

The disclosed embodiments may have one or more Use-Case diagrams or documents associated with it. The UC's may describe the Actors (i.e., users or user classes) that may be using a particular screen or variation of that screen, what they are allowed to do and what the expected results are. The UC documents may describe in simple terms the business logic behind the data entry screens.

The application may be divided into several component parts or modules. Each module has one or more use-case descriptions specifying what you can do and where. The following may be the primary modules in this application:

System Log-in

Project

User

Company

Map

All required functionality in this application may be obtained from navigating from one of these areas. Once a user logs in, they generally may be sent to the Active Projects page. This may be the home page for the application as everything can be accessed from here.

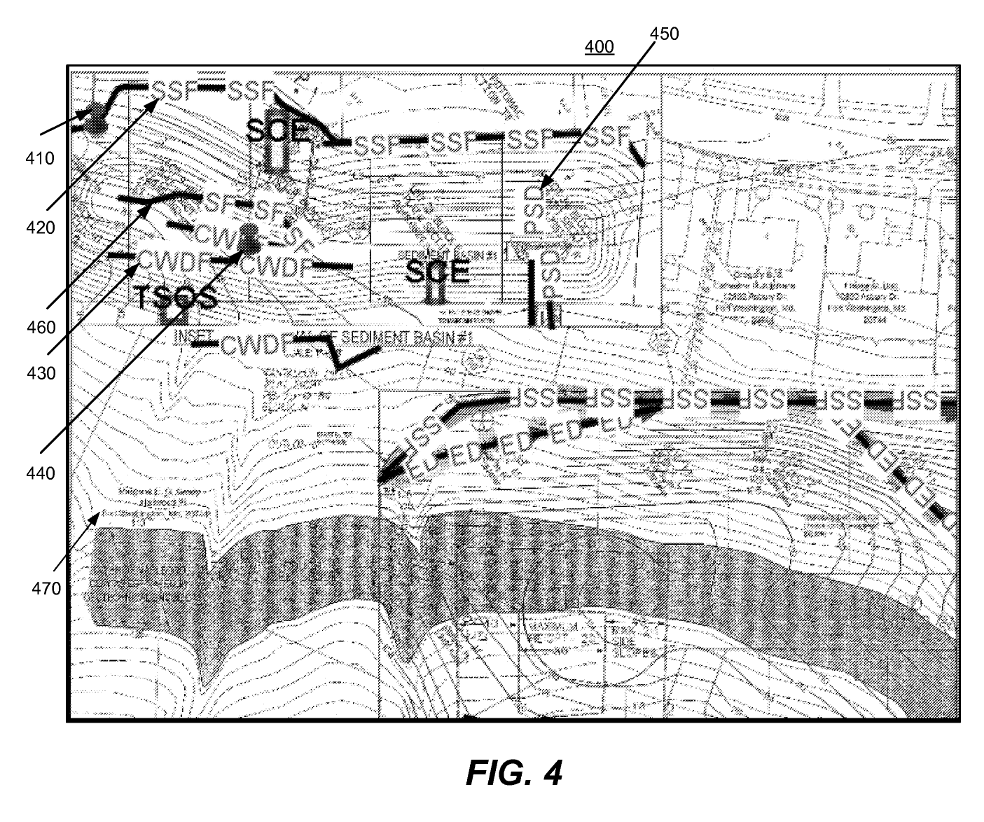

In general, the primary function and most critical part of this application may be the MAP module. The focus of the other parts of the application may be to support the editing functions of the map and inspection reporting. The map module is discussed below in relation to FIG. 4.

International Support. In Phase 1, the SWPPP system may have built-in support for only the continental U.S. Built-in support may mean that all the data entry screens have fields appropriate for a particular country. However, it may still be possible in Phase 1 to add international customers into the database, and the system may be built such that international functionality can be added as early as the beginning of Phase 2. Phase 1 may also include the use of international language descriptors where applicable, such as “state/province,” and “postal code.”

The in supporting the continental U.S., there may be a need to standardize references to states and counties (or territories of any kind), which can usually only be done by loading all of the county codes and names, etc. for a particular county with-in a State, for example.

There may be numerous contemplated modifications and enhancements associated with the various embodiments of the SWPPP program. These may include, but are not limited to, the capability to allow customers to set up their own accounts and logins, load maps, overload new maps or partial maps, include links to County, State and Local Best Management Practices (BMPs) for construction sites, include links to relevant GIS for project planning and information purposes prior to construction, include links to relevant regulations from such jurisdictions relating to construction sites, provide information on the “environmental responsibilities” for specific building trades, and provide information on new and innovative technologies that may be used to help with environmental site compliance.

Actors may be general categories to which user accounts may be assigned for the purpose of determining access permissions (i.e., who is allowed to do what). These may be categories of people, or they can refer to other systems. For example, in general, a person having a user account may be designated as a Super Admin, Company Admin, Company Inspector, or a General User, for example.

The SWPPP system may recognize the above-listed actors as having the following characteristics:
Super Admin. The Super Admin may have master rights to do everything the other users can do, plus special administrator abilities.
Company Admin. Each customer may typically have one Company Admin, who has full rights within the system for their company. These rights may include administering all user accounts for the company.
Company Inspector (could be a manager/president, project manager, superintendent, or third party inspector, for example). Someone employed by the company or hired by the company to perform inspection(s) on their job(s). This actor may also have rights to edit the SWPPP elements.
General User (could be an employee of a contractor or subcontractor). This would be someone who has access to view particular projects/maps, but may not edit them.

Other systems:
Scheduling System. This refers to the task scheduler on the server hosting the application, that may be used for emailing reminders. This function may be called “Exception Reporting” and may send emails to designated persons to alert them that an inspection is due or past due.

The process may be divided into several component parts or modules. The following are the primary modules in this process:

Implementation Plan. Use cases to be implemented in phase I: The functionality to view best management practices (BMPs) may be implemented by creating county or state links to regulations and/or BMP details from the project screen. In general, there may be no feature to support grandfathering of outdated BMPs, because the BMP link must point to an active web page. However, embodiments may be contemplated in which outdated BMPs may be supported, if they are on an active web page or on a case-by-case basis.

In accordance with one or more embodiments of the present invention, the use cases to be implemented in phase II may include:
Modify Company
Retire Company
Search Companies
Edit User Privileges (so that privileges are not necessarily based on a user's type)
View Best Management Practices
Extension to the Edit Privileges use case to allow more specific permissions, both company-level and project-level
Cancel Project
Reactivate Project (“un-cancels” or resumes a project)
Other use cases TBD

In accordance with one or more embodiments of the present invention, the use cases to be implemented may include:
View Site Plan History Report—a report showing the full history of the site, including which elements were moved/created/etc. and when.
View Map History—a more detailed, specific history of the map.

In accordance with an embodiment of the present invention, a product may be implemented as a subscription-based, comprehensive environmental information system. For example, it may be implemented as a web enabled database to provide the user with current environmental compliance information for whatever job site he or she is currently working on. It may provide the user an opportunity to view all relevant regulations, properly perform site inspections to maintain compliance, provide a means to update storm water pollution prevention plans (SWPPPs), track compliance issues and inspections for a specific or all job sites associated with the particular client, provide the user with concise inspection reporting forms to work with compliance inspector's requirements and provide updates on the latest environmental and compliance news.

The system may be used by construction and compliance managers on the job site, whether at a desktop computer or portable laptop to keep up to date on all site compliance issues. In general, the system may be designed so that County, State and Federal inspection departments may endorse the system's use and use it themselves to improve the efficiency of their compliance inspection workload. In addition, County, State and Federal regulators who are responsible for performing inspections on their jurisdiction's BMPs every 3 years, may be able to subscribe to this system to record their inspection reports as required under the Clean Water Act. Initially, in accordance with an embodiment of the present invention, the product may be prepared to work over the entire Chesapeake Bay watershed to demonstrate its capability to operate on a large scale, as well as in national and international markets that are just beginning to understand major environmental issues.

In addition to the information architecture described herein and/or attached hereto, embodiments are contemplated in which, some or all of the following may also be implemented individually and/or in any combination: 1. In the user area, each user may have multiple projects associated with their user name from which they can select a desired project; 2. The user area may include a web page titled “How to conduct a field inspection”; 3. “Project Data” may be used to link to relevant GIS to provide relevant information relating to particular construction sites; and 4. The Erosion and Sedimentation Control Plans may be connected to the inspection report. The system may also be adapted to permit the user to be able to do the site inspection, get to the computer, input any changes in the BMPs, which then automatically updates the SWPPP. Then, the user may be able to print the report, so it can be posted on the site.

Still further embodiments are contemplated in which, some or all of the following may also be implemented individually and/or in any combination:
All of the databases may either be populated automatically or by a staff member as appropriate.
The project database may be populated directly from the project creation screen.
A staff member or a third party vendor will authenticate the accuracy of the data in the regulations database.
A data dictionary may be developed to first ensure that we have all on the needed information necessary for front end applications.
It may not be necessary to have the user provide the URL's for government regulations.
The billing functions of the system may have an interface with other organizations that provide credit card validation and authorization.
The system may need to deal with license fees on GIS interfaces and software applications.
The system may include a “Green” page in the user area that provides links to “green building information”.

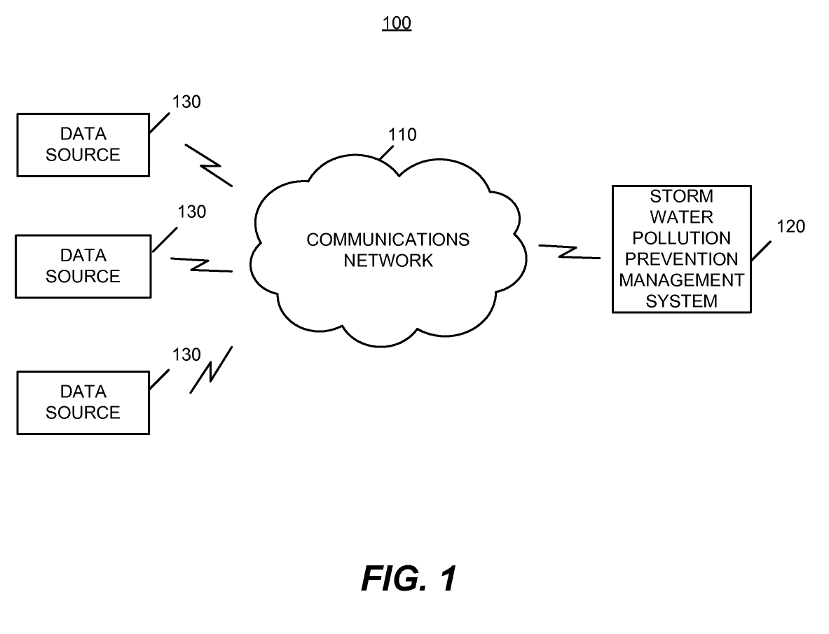

FIG. 1 is an exemplary diagram of a storm water pollution prevention management environment 100 in accordance with a possible embodiment of the disclosure. The storm water pollution prevention management environment 100 may include a storm water pollution prevention management system unit 120, and one or more data sources 130, all connected through communications network 110. Note that although the connections in FIG. 1 are shown as a wireless configuration, one or more of these connections may also be wired.

Communications network 110 may represent any communications network used to communicate with other entities, including the Internet, an intranet, a radio network, a wireless network, etc. The one or more data sources 130 may be include one or more databases that contain information for dissemination to the storm water pollution prevention management system 120 for construction site-related information, such as site plans, building codes, grading regulation, erosion and sediment control plans, etc., for example. The storm water pollution prevention management system 120 may be any server, computer, a smartphone, processing device, personal digital assistant (PDA), or other similar device capable of storing and managing media publications and other documents and products.

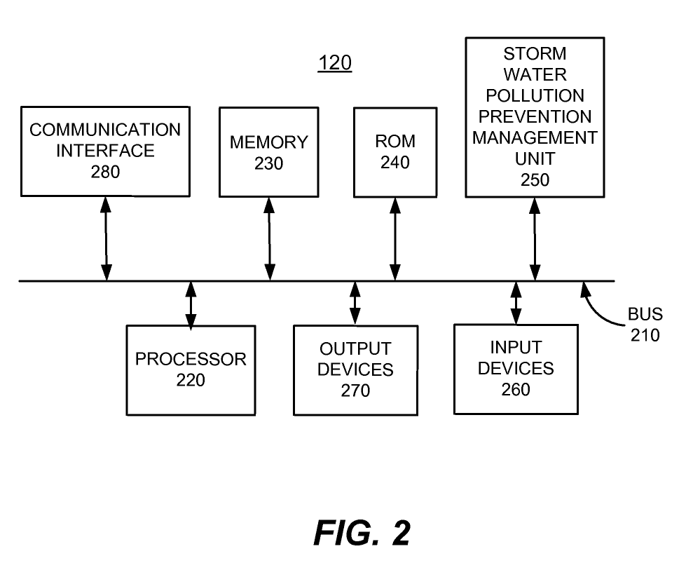

FIG. 2 is an exemplary block diagram of a storm water pollution prevention management system 120 in accordance with a possible embodiment of the disclosure. The exemplary storm water pollution prevention management unit 120 may include a bus 210, a processor 220, a memory 230, a read only memory (ROM) 240, a storm water pollution prevention management unit 250, input devices 260, output devices 270, and a communication interface 280. Bus 210 may permit communication among the components of the storm water pollution prevention management system 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any type of storage media or media drive, such as, for example, magnetic or optical recording media and its corresponding drive.

Input device 260 may include one or more conventional mechanisms that may permit a user to input information to the storm water pollution prevention management system 120, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the storm water pollution prevention management unit 250 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections.

The storm water pollution prevention management system 120 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device, or from a separate device via communication interface 280.

The storm water pollution prevention management system 120 illustrated in FIGS. 1-2 and the related discussion are intended to provide a brief, general description of a suitable computing environment in which the disclosure may be implemented. Although not required, the disclosure will be described, at least in part, in the general context of computer-executable instructions, such as program modules, being executed by the storm water pollution prevention management system 120, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

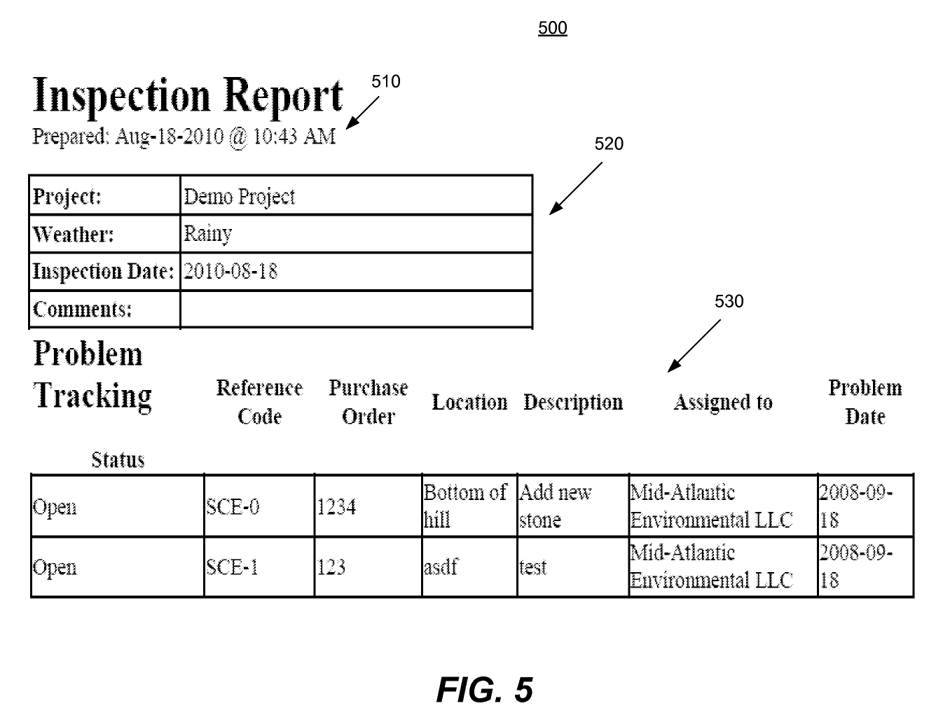

For illustrative purposes, the operation of the storm water pollution prevention management unit 250 and the storm water pollution prevention management process will be described below in FIG. 5 in relation to the block diagrams shown in FIGS. 1-2.

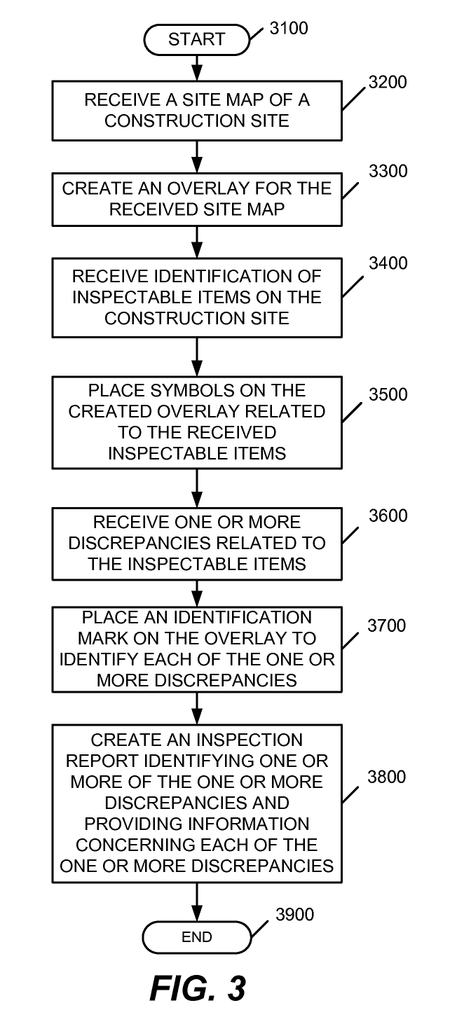

FIG. 3 is an exemplary flowchart of a storm water pollution prevention management process in accordance with one possible embodiment of the disclosure. The process begins at step 3100 and continues to step 3200 where the storm water pollution prevention management unit 250 may receive a site map of a construction site. At step 3300, the storm water pollution prevention management unit 250 may create an overlay for the received site map. At step 3400, the storm water pollution prevention management unit 250 may receive identification of inspectable items on the construction site. At step 3500, the storm water pollution prevention management unit 250 may place symbols on the created overlay related to the received inspectable items. The overlay may be interactive and the storm water pollution prevention management unit 250 may receive an indication on one of the identification marks on the overlay. The indication may be a mouse click, keyboard entry, soft keypad entry, hard keypad entry, a press from a user's finger or a press from a stylus, for example, and the storm water pollution prevention management unit 250 may provide information concerning the one or discrepancy related to the indicated identification mark.

At step 3600, the storm water pollution prevention management unit 250 may receive one or more discrepancies related to the inspectable items. At step 3700, the storm water pollution prevention management unit 250 may place an identification mark on the overlay to identify each of the one or more discrepancies. The overlay may be interactive and the storm water pollution prevention management unit 250 may receive an indication on one of the identification marks on the overlay. The indication may be a mouse click, keyboard entry, soft keypad entry, hard keypad entry, a press from a user's finger or a press from a stylus, for example, and the storm water pollution prevention management unit 250 may provide information concerning the one or discrepancy related to the indicated identification mark.

At step 3800, the storm water pollution prevention management unit 250 may create an inspection report identifying one or more of the one or more discrepancies and providing information concerning each of the one or more discrepancies. The storm water pollution prevention management unit 250 may send the site map and/or the inspection report to the responsible agency and/or the party responsible for correcting the one or more discrepancy identified in the inspection report. The storm water pollution prevention management unit 250 may send a notification assigning one or more inspector to inspect one or more discrepancy. The storm water pollution prevention management unit 250 may store the overlay and/or the inspection report in a memory 230. In this manner, the overlay and/or the inspection report may be provided as a part of an historical report related to the construction site. The process may then go to step 3900 and end.

FIG. 4 is an exemplary site map overlay 400 showing discrepancies in accordance with a possible embodiment of the disclosure. The elements of the site map overlay 400 may be include identification of the property address or plat numbers 470 and site features as in this example Super Silt Fent (SSF) 420, Central Waste Disposal Facility (CWDF) 430, Pipe Slope Drain (PSD) 450, and Silt Fence (SF) 460. Discrepancies 410, 440 in the construction site features may be identified by identification marks, such as an icon for a push pin, as shown. However, other icons for identification marks may be used.

The site map overlay 400 templates may be changeable so that enhancements can be made to the color scheme, graphic elements, etc. In Phase 1, the site map overlay 400 may be created by manually “knitting” the various drawings together to create one complete image that can be uploaded as the site plan for a project. The site map overlay 400 may contain date and time stamped layers to allow for reviewing a visual map history over a definable time sequence. In Phase 1, site map overlay 400 history may be implemented with the ability to choose a previous inspection date and see what the inspection pushpins 410, 440 looked like at that time (as well as view information about them). As discuss above, the site map overlay 400 may contain a palette of elements or site features, such as a silt fence, a dumpster, a paint washout station, etc., which may be represented in icon form and may be dropped onto the site map overlay 400 surface. Some elements, such as, for example, the silt fence, may be resizable, and others, such as, for example, the dumpster, may not be. Some elements, such as, for example, the Silt Fence, will be resizable and scalable as the user zooms in and out using the mouse. Other elements, such as, for example, the dumpster, may not be resizable, but may be scalable as the user zooms in and out.

The site map overlay 400 may allow for logging and recording of Inspection Events and problems noted during the inspection may be noted on the site map overlay 400 with a red (or other color) push-pin (or other identification mark (icon)) element 410, 440. The inspector (i.e., the one placing the red push-pin 410, 440), can add notes about the problem including who the problem was delegated to for resolution, through a box that will appear when noting a problem from an inspection. This box may include spaces to assign the deficiency to a specific subcontractor, assign a purchase order number and give a detailed description of the problem.

Once a problem is resolved, the inspector can log into the system and note same, at which time the red pushpin 410, 440 may turn green (or other color) to visually indicate the problem as resolved. At any time, an outstanding problem report or inspection report may be run that can list the status of all outstanding problems. A user may go into a history reporting section and review the status of a specific date's inspection and view all red and green pushpins as well as the report for that date's inspection. In general, green push-pins may not carry over (i.e., will not be visible) in future inspections, however, red push pins may continue onto the following inspection reports and maps until the issue is resolved. After problems are marked as resolved, the push-pin may turn green to visually indicate that the problem has been resolved.

The site map overlay 400, generally, may have an Inspection Mode and an Edit Mode. The Inspection and Edit modes may serve two different purposes. The Inspection Mode may allow a site inspector to log an inspection event, note problems, make comments, etc. These comments and notes, generally, become part of the site history and are used, in part, to create the inspection log report for the inspection. In general, one log report may be created for each inspection. The Edit Mode may allow the project manager to update the map with new elements, or reposition or remove elements as needed. All modifications to the site map overlay 400 may be stored in time sequence order to allow for future time-history playback and review. This time stamping function can be critical when determining the sequencing of items on the inspection reports.

FIG. 5 is an exemplary inspection report 500 identifying discrepancies on a site in accordance with a possible embodiment of the disclosure. The inspection report 500 may include time stamp information 510, project description data 520, and discrepancy identification information 530, for example. Other information may be provided as needed, however.

Embodiments within the scope of the present disclosed embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosed embodiments are part of the scope of the disclosed embodiments. For example, the principles of the disclosed embodiments may be applied to each individual user where each user may individually deploy such a system. This enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

We claim:

1. A method of storm water pollution prevention management using a storm water pollution prevention management system, comprising:
receiving a site map of a construction site;
creating an overlay for the received site map;
receiving identification of inspectable items on the construction site;
placing symbols on the created overlay related to the received inspectable items;
receiving one or more discrepancies related to the inspectable items;
placing an identification mark on the overlay to identify each of the one or more discrepancies; and
creating an inspection report identifying one or more of the one or more discrepancies and providing information concerning each of the one or more discrepancies.

2. The method of claim 1, further comprising:
determining where on the overlay each particular discrepancy is to be displayed.

3. The method of claim 1, further comprising:
sending at least one of the site map and the inspection report to at least one of a responsible agency and a party responsible for correcting the one or more discrepancy identified in the inspection report.

4. The method of claim 1, further comprising:
storing at least one of the overlay and the inspection report in a memory, wherein at least one of the overlay and the inspection report are provided as a part of an historical report related to the construction site.

5. The method of claim 1, wherein the overlay is interactive and further comprising:
receiving an indication on one of the identification marks on the overlay, wherein the indication is one of a mouse click, keyboard entry, soft keypad entry, hard keypad entry, a press from a user's finger and a press from a stylus; and
providing information concerning the one or discrepancy related to the indicated identification mark.

6. The method of claim 1, further comprising:
sending a notification assigning an inspector to inspect one or more discrepancy.

7. The method of claim 1, wherein the storm water pollution prevention management system is one of a server, a computer, a personal digital assistant (PDA), a smartphone, and a processing device.

8. A storm water pollution prevention management system, comprising:
a communication interface that facilitates the sending and receiving data; and
a storm water pollution prevention management unit that receives a site map of a construction site, creates an overlay for the received site map, receives identification of inspectable items on the construction site, places symbols on the created overlay related to the received inspectable items, receives one or more discrepancies related to the inspectable items, places an identification mark on the overlay to identify each of the one or more discrepancies, and creates an inspection report identifying one or more of the one or more discrepancies and providing information concerning each of the one or more discrepancies.

9. The storm water pollution prevention management system of claim 8, wherein the storm water pollution prevention management unit determines where on the overlay each particular discrepancy is to be displayed.

10. The storm water pollution prevention management system of claim 8, wherein the storm water pollution prevention management unit sends at least one of the site map and the inspection report to at least one of a responsible agency and a party responsible for correcting the one or more discrepancy identified in the inspection report.

11. The storm water pollution prevention management system of claim 8, wherein the storm water pollution prevention management unit stores at least one of the overlay and the inspection report in a memory, wherein at least one of the overlay and the inspection report are provided as a part of an historical report related to the construction site.

12. The storm water pollution prevention management system of claim 8, wherein the overlay is interactive and the storm water pollution prevention management unit receives an indication on one of the identification marks on the overlay, wherein the indication is one of a mouse click, keyboard entry, soft keypad entry, hard keypad entry, a press from a user's finger and a press from a stylus, and provides information concerning the one or discrepancy related to the indicated identification mark.

13. The storm water pollution prevention management system of claim 8, wherein the storm water pollution prevention management unit sends a notification assigning an inspector to inspect one or more discrepancy.

14. The storm water pollution prevention management system of claim 8, wherein the storm water pollution prevention management system is one of a server, a computer, a personal digital assistant (PDA), a smartphone, and a processing device.

15. A computer-readable medium storing instructions for controlling a computing device for storm water pollution prevention management using a storm water pollution prevention management system, the instructions comprising:
receiving a site map of a construction site;
creating an overlay for the received site map;
receiving identification of inspectable items on the construction site;
placing symbols on the created overlay related to the received inspectable items;
receiving one or more discrepancies related to the inspectable items;
placing an identification mark on the overlay to identify each of the one or more discrepancies; and
creating an inspection report identifying one or more of the one or more discrepancies and providing information concerning each of the one or more discrepancies.

16. The computer-readable medium of claim 15, further comprising:
determining where on the overlay each particular discrepancy is to be displayed.

17. The computer-readable medium of claim 15, further comprising:
sending at least one of the site map and the inspection report to at least one of a responsible agency and a party responsible for correcting the one or more discrepancy identified in the inspection report.

18. The computer-readable medium of claim 15, further comprising:
storing at least one of the overlay and the inspection report in a memory, wherein at least one of the overlay and the inspection report are provided as a part of an historical report related to the construction site.

19. The computer-readable medium of claim 15, wherein the overlay is interactive and further comprising:
receiving an indication on one of the identification marks on the overlay, wherein the indication is one of a mouse click, keyboard entry, soft keypad entry, hard keypad entry, a press from a user's finger and a press from a stylus; and
providing information concerning the one or discrepancy related to the indicated identification mark.

20. The computer-readable medium of claim 15, further comprising:
sending a notification assigning an inspector to inspect one or more discrepancy.

21. The computer-readable medium of claim 15, wherein the storm water pollution prevention management system is one of a server, a computer, a personal digital assistant (PDA), a smartphone, and a processing device.
